(19) United States
(12) Patent Application Publication
(10) Pub. No.: US 2008/0155892 A1
(43) Pub. Date: Jul. 3, 2008

(54) Irrigation kit and method for use thereof

(76) Inventors: Alon Katzir-Shimoni, Haifa (IL); Daniel Feinberg, Zichron Yaakov (IL); Gil Feldman, Pardesiya (IL)

Correspondence Address: THE NATH LAW GROUP, 112 South West Street, Alexandria, VA, 22314, US

(21) Appl. No.: 11/987,007

(22) Filed: Nov. 26, 2007

(30) Foreign Application Priority Data
Dec. 28, 2006 (DE) 202006019527.0

(51) Int. Cl. A01G 25/00; A01G 25/02; G09B 19/00; G09B 25/00

(52) U.S. Cl. 47/39; 434/126; 434/365; 47/48.5

(57) ABSTRACT

An irrigation kit comprising a set of irrigation elements adapted for construction of an irrigation system dedicated to a certain manner of growing plants and an educational media adapted to be understood by children, which includes instructions to assemble the irrigation elements to construct the irrigation system. Each such kit is adapted for irrigation of plants to be grown in different manners (e.g. in a field, a garden or a pot, etc.) and it comprises an appropriate set of irrigation elements for construction of an irrigation system therefor.

### FIELD OF THE INVENTION

This invention relates to educational kits for constructing fluid-piping systems.

### BACKGROUND OF THE INVENTION

GB 2048088 discloses a fluid-piping system construction set for educating children about fluid pressure and transportation of fluids via the construction and use of fluid-piping elements in the set such as pipes, pipe connectors, etc.

U.S. Pat. No. 6,561,810 discloses a method and kit for teaching children about fluid pressure in basic fluid-piping systems. The kit comprises pipes, pipe connectors, and an educational media element adapted to be comprehended by children about the manner in which the pipes and pipe connectors may be interconnected with one another to form a variety of operable fluid piping systems. The kit optionally includes a storage container for storing the other elements of the kit when not in use. One example kit described comprises a pressure indicator and a first and second sprinkler for teaching a child about fluid pressure characteristics of basic fluid-piping systems, and consequently the educational media includes explanations of how to compare the different fluid pressures in a piping systems comprising a first and a second sprinkler.

### SUMMARY OF THE INVENTION

In accordance with one aspect of the present invention, there is provided an irrigation kit comprising a set of irrigation elements adapted for construction of an irrigation system dedicated to a certain manner of growing plants and an educational media adapted to be understood by children, which includes instructions to assemble the irrigation elements to construct the irrigation system.

For the purposes of the specification and claims the word plant includes all types of crops, trees, seeds for growing such, and like items that grow in an area having soil such as a field, garden or pot, etc., and that may be grown via irrigation thereof.

Examples of irrigation elements which may be included in the set of irrigation elements are: pipes, a connecting assembly for connecting at least one of the pipes to a fluid source, pipe connectors adapted for connecting pipes to each other, pipe plugs, pressure indicators, filter elements for filtering fluid from the fluid source, anchoring elements for anchoring portions of the pipes in a desired arrangement, fluid emitters integrally formed with or attachable to the pipes via which fluid from the pipes is to be emitted to plants to be irrigated, pots, seeds, caps to be worn for protection against the sun, signs with plant names, etc.

The kit according to the invention may further comprise a tank adapted for mounting in an elevated position relative to other elements of an irrigation system it is a part of and for holding an amount of fluid. The tank may be designed to allow the connection of a pipe thereto such that the pipe may receive pressurized fluid therefrom, and to thereby constitute a low pressure fluid source. The tank may have detachable legs and may be sized to efficiently house all other elements of the kit including the detachable legs therein. The legs may have an adjustable length. The tank may comprise a connecting assembly for connection of a pipe thereto. The connecting assembly may include a faucet.

Some of the irrigation elements in the set may be pre-assembled to ease construction of the irrigation system.

According to another aspect of the present invention, there is provided a method for educating children about irrigation comprising the following steps:
(a) providing a set of irrigation elements adapted for construction of an irrigation system dedicated to a certain manner of growing plants;
(b) providing an educational media adapted to be understood by children which includes instructions to assemble the irrigation elements to construct the irrigation system.

According to any of the above aspects, the educational media may be adapted to be understood by children within a predefined age group. This may be accomplished by the media comprising colored pictures or pictures free of text. Additionally, the media may comprise a computer program which may be included in the kit on a program storage device readable by machine, tangibly embodying a program of instructions executable by the machine. The storage device, for example, may be in the form of a compact disc or a computer hard drive. When run on a computer, the program may be adapted to prompt for and receive inputs from a user via the computer and to subsequently display appropriate information and the instructions in accordance with the inputs received. An input may be an age group parameter, in which case the computer may display the irrigation information and the instructions at a level of sophistication suitable for the selected age group. Additionally, the computer program may be adapted for causing the computer to display an irrigation simulation. The simulation displayed may be based on and varied in accordance with computer inputs made by a user in the form of selected irrigation parameters. The irrigation parameters may be a code or name representing a set of virtual irrigation elements, or a virtual irrigation element or a virtual plant type or a virtual environmental condition or a virtual area dimension or an arrangement for virtual irrigation elements. The virtual irrigation elements may be virtual representations of the set of irrigation elements provided in the kit or the virtual irrigation elements may be virtual representations of other real irrigation elements. Additionally, the irrigation simulation may comprise a score system which enables a user to subsequently input additional irrigation parameters. Alternatively, the simulation may be part of a website adapted to augment the information and the instructions in the educational media.

The educational media may also include irrigation information about the growing of plants and educational elements to aid the understanding thereof.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is a schematic view of a field irrigation system, constructed from irrigation elements comprised in a kit, according to one example of the present invention;

FIG. 2 is a schematic view of a fluid source which may constitute a part of the irrigation system shown in FIG. 1, the fluid source comprising a water tank and a pre-assembled tank faucet assembly;

FIG. 3 is a schematic view of the tank faucet assembly shown in FIG. 2, disassembled;

FIG. 4 is a schematic view of a pot irrigation system, constructed from irrigation elements comprised in a kit, according to another example of the present invention;

FIG. 5 is a schematic view of a fluid source to which the irrigation system shown in FIG. 4, is adapted for being connected, and elements which may be included for this purpose in the kit of such irrigation system;

FIG. 6 is a schematic view of a garden irrigation system, constructed from irrigation elements comprised in a kit including a plurality of sprinkler-stake assemblies, according to a still further example of the present invention;

FIG. 7 is a schematic view of a fluid source to which the irrigation system shown in FIG. 6, is adapted for being connected, and elements which may be included for this purpose in the kit of such irrigation system;

FIG. 8 is a schematic view of one of the sprinkler-stake assemblies shown in FIG. 6, disassembled;

FIG. 9A illustrates an example set of irrigation elements in a kit for construction of an irrigation system dedicated to the manner of growing plants illustrated in FIG. 1;

FIG. 9B illustrates an example set of irrigation elements in a kit for construction of an irrigation system dedicated to the manner of growing plants illustrated in FIG. 4;

FIG. 9C illustrates an example set of irrigation elements in a kit for construction of an irrigation system dedicated to the manner of growing plants illustrated in FIG. 6; and

FIGS. 10 to 23 illustrate different operations by which the irrigation systems illustrated in FIGS. 1, 4 and 6, may be assembled from elements shown in FIGS. 9A, 9B and 9C.

### DETAILED DESCRIPTION OF EXEMPLARY EMBODIMENTS

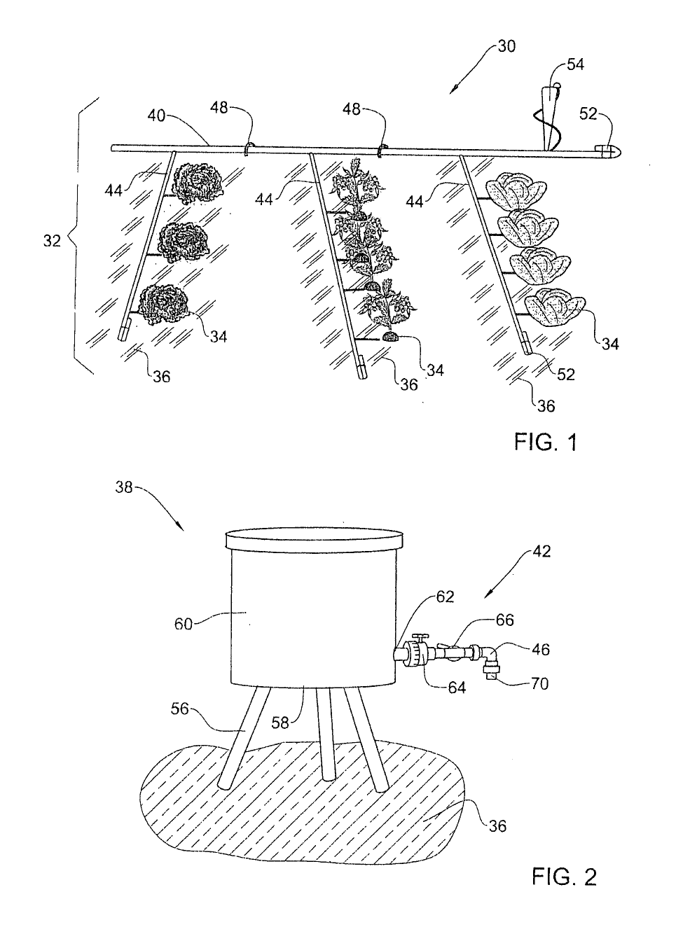

FIGS. 1, 4 and 6 illustrate irrigation systems constructed from irrigation elements included in kits according to different examples of the present invention. Each such kit is adapted for irrigation of plants to be grown in different manners (e.g. in a field, a garden or a pot) and it comprises an appropriate set of irrigation elements for construction of an irrigation system therefor and an educational media adapted to be understood by children which includes irrigation information about the growing of plants and instructions to assemble the irrigation elements to construct said irrigation system.

FIG. 1 illustrates an irrigation system 30 installed in a field 32 for the irrigation of a plurality of plants 34 disposed in soil 36. The irrigation system 30 is constructed from a set of irrigation elements which comprises: a main pipe 40 having a first diameter for transporting fluid from a fluid source (not shown in FIG. 1); a plurality of branch pipes 44 having a second diameter which optionally is smaller than the first diameter of the main pipe 40 and having fluid emitters (not seen) via which fluid received in the branch pipes 44 from the main pipe 40 is emitted to the plants 34; a plurality of connector elements (not shown in FIG. 1) for connecting the branch pipes 44 to the main pipe 40 in a desired arrangement and for connecting the main pipe 40 to the fluid source; a plurality of U-shaped pins 48 for anchoring the main pipe 40 and the branch pipes 44 to the soil 36; a plurality of plugs 52 for plugging the ends of the main pipe 40 and the branch pipes 44; and a pressure indicator 54 for indicating fluid pressure in the system 30. Notably, the example pressure indicator 54 shown comprises a re-settable pop-up flag (not shown in FIG. 1) which elevates to a raised position to indicate when the fluid pressure in a connected pipe is detected above a predetermined threshold. The fluid emitters in the branch pipes 44 of the irrigation system 30 may be either in the form of drip emitters mounted within the branch pipes 44 or in the form of holes formed therewith either when the pipes 44 are produced or when the irrigation system 30 is constructed in the field 32. To punch such holes in the pipes 44 for emitting fluid to the plants 34 or for connecting the main pipe 40 thereto, the kit for the irrigation system 30 may further comprise a puncture tool (not shown in FIG. 1).

FIG. 2 illustrates a tank 38 with a tank faucet assembly 42, both of which may be included as irrigation elements in the kit for the irrigation system 30 (FIG. 1) to constitute a low pressure fluid source therefor. The tank 38 comprises detachably attachable legs 56 for elevating the tank 38 above the soil 36, a base 58 adapted for screwable connection with the legs 56, a wall 60 extending in a substantially perpendicular direction from the periphery of the base 58, and an internally threaded aperture 62 formed within the wall 60 and disposed adjacent to the base 58. The location of the aperture 62 relative to the base 58 and the height of the legs 56 are selected so as to provide the system 30 with a predetermined maximal fluid pressure. The tank 38 is sized to accommodate a desired amount of water and to efficiently house all other irrigation elements of the kit including the detachable legs 56 therein, so that it doubles as a container for the kit when not in use. The fluid pressure required for operation of the irrigation system 30 using the tank 38 is created by gravitational forces on fluid in the tank 38 and fluid which has exited the aperture 62 and is descending along the main pipe 40 towards the soil 36. Thus the fluid pressure in the system 30 is dependent on the amount of fluid in the tank 38 and the height of the aperture 62 above the soil 36.

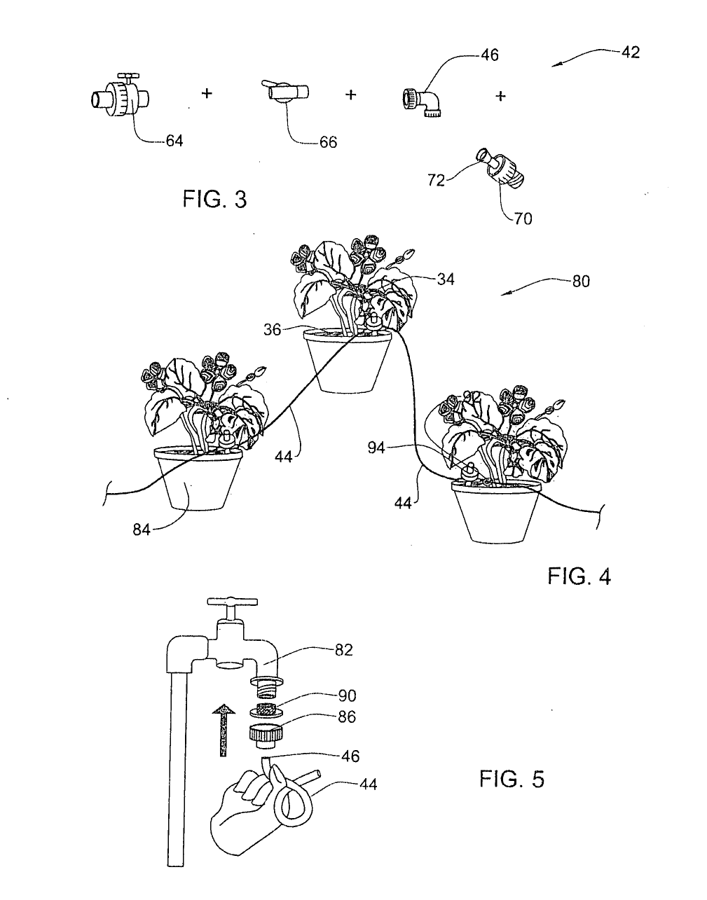

Regarding the tank faucet assembly 42 shown in FIG. 2, whose elements are shown separately in FIG. 3, this assembly 42 comprises a detachably attachable faucet 64 adapted to sealably connect to the aperture 62 of the tank 38, a flow regulator element 66 adapted to sealably connect to the faucet 64 and regulate fluid flow therefrom, a connector element 46 adapted to sealably connect to the flow regulator element 66 and redirect fluid flow therefrom towards the soil 36, an adaptor 70 for sealable connection between the connector 46 and the main pipe 40, and a filter element 72 (FIG. 3) housed in the adaptor 70 for filtering fluid that passes therethrough.

FIG. 4 illustrates an irrigation system 80 installed in a sequence of pots 84 each comprising soil 36 and a plant 34. The irrigation system 80 is constructed from a set of irrigation elements which comprises: pipes 44 which may have the same diameter as the branch pipes 44 in the irrigation system 30 described above, but may be shorter in length for transporting fluid from a fluid source (not shown in FIG. 4) to at least one of the pots 84 and from one pot 84 to another; a plurality of connector elements (not shown in FIG. 4), which may be the same as some of the connector elements 46 in the irrigation system 30 described above, for connecting the pipes 44 to each other and the fluid source thereby facilitating a desired arrangement of the system 80; a plurality of stakes 92 for securing the pipes 44 to the soil 36 the pots 84; and a plurality of fluid emitters 94 connected to the pipes 44 for emitting fluid therefrom to the plants 34.

FIG. 5 illustrates a faucet 82 disposed near to the irrigation system 80 and elements for the connection of the pipe 44 of the system 80 (FIG. 4) thereto, the faucet 82 thereby constituting a pressure fluid source therefor. The elements for connecting the faucet 82 and the pipes 44 are irrigation elements in the kit for the irrigation system 80 and comprise a faucet adaptor 86 for sealable connection to the faucet 82, a connector element 46 for connecting the pipe 44 to the adaptor 86, and a filter element 90 housed in the faucet adaptor 86 for filtering fluid that passes therethrough.

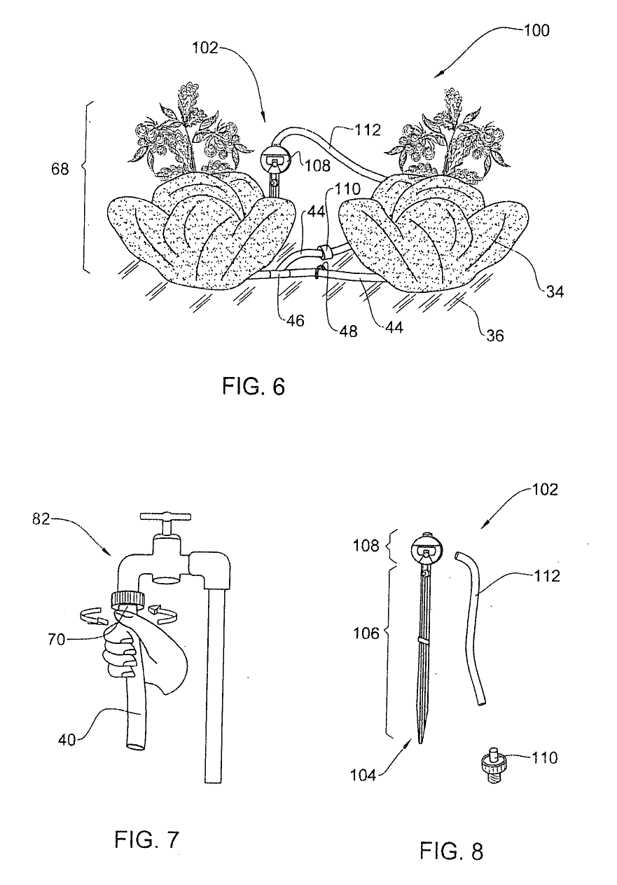

FIG. 6 illustrates an irrigation system 100 installed in a garden 68 for the irrigation of a plurality of plants 34 disposed in soil 36. The irrigation system 100 is constructed from a set of irrigation elements which comprises: a main pipe 40 (not shown in FIG. 6) which optionally has the same diameter as the main pipe 40 in the irrigation systems (30, 80) above for transporting fluid from a fluid source (not shown in FIG. 6); a plurality of branch pipes 44, which may have the same diameter as the branch pipes 44 in the irrigation systems (30, 80) above, for receiving fluid from the main pipe 40; a plurality of connector elements 46 for connecting the pipes (40, 44) in a desired arrangement; a plurality of U-shaped pins 48 for securing the pipes (40, 44) in the arrangement; a plurality of plugs (not shown in FIG. 6) for plugging the ends of the pipes (40, 44); a plurality of pre-assembled sprinkler-stake assemblies 102 connected to the branch pipes 44 for emitting fluid therefrom to the plants 34; a puncture tool (not shown in FIG. 6) for forming holes 50 (not seen) in the pipes (40, 44); and a pressure indicator (not shown in FIG. 6) for indicating fluid pressure in the system 100.

FIG. 7 illustrates a faucet 82 and elements for the connection thereof to the main pipe 40 of the system 100 (FIG. 6) to constitute a pressure fluid source therefor. The elements for connecting the faucet 82 and the main pipe 40 are irrigation elements in the kit for the irrigation system 100 and comprises an elongated faucet adaptor 70 adapted for sealable connection between the faucet 82 and the main pipe 40, and an elongated filter element (not shown in FIG. 7) housed in the elongated faucet adaptor 70 for filtering fluid (not shown) that passes therethrough.

Regarding the pre-assembled sprinkler-stake assemblies 102 shown in FIG. 6, whose elements are shown separately in FIG. 8, each assembly 102 comprises: a sprinkler-stake element 104 having a first portion in the form of an elongated tip 106 adapted for being driven into the soil 36 (FIG. 6), and a second portion in the form of an integral sprinkler 108; a drip emitter 110; and a connecting pipe 112 for connecting the drip emitter 110 to the integral sprinkler 108 of the sprinkler-stake. When connected to the drip emitter 110, the integral sprinkler 108 works in substantially the same way as a regular sprinkler with the exception that the sprinkling action is regulated to the regulated drip flow it receives from the drip emitter 110. This ensures that sprinkler-stake assemblies 102 of an irrigation system that are located at different heights in relation to each other will produce similar sprinkling actions.

It should be noted that the pipes (40, 44) described above may be included in the corresponding kits as a plurality of pipes with predetermined lengths or, preferably, are provided of a sufficient length for cutting into sections having a desired length, when the irrigation systems (30, 80, 100) are constructed. Additionally, it should be emphasized that the pipe diameters discussed above are examples only and, for example, the diameter of the main pipe 40 for the irrigation system 30 may alternatively have a diameter larger than the main pipe 40 for the irrigation system 100.

To build any of the irrigation systems (30, 80, 100) described above, a user following the instructions provided in the educational media (not shown), makes some or all of the following steps: cutting appropriate lengths of the pipes to suit the irrigation system to be constructed; punching holes in the pipes using the puncture tool for fluid to be emitted therethrough or for connection to other pipes; arranging and connecting the pipes using the plurality of connectors to form a desired arrangement; anchoring the pipes to the soil using anchoring elements to maintain the arrangement; connecting the emitters to the pipes; plugging open pipe ends using plugs; attaching a pressure indicator to a pipe; sealably connecting the pipes to the fluid source via any necessary elements; and filling the tank with water from an external source.

To operate the constructed irrigation systems (30, 80, 100) a user, following the instructions provided in the educational media (not shown), and using the irrigation information to appropriately regulate the fluid for irrigation of the plants in the system, makes some or all of the following steps: releasing a fluid flow from the fluid source by opening the faucet for irrigation of the plants via the fluid emitters; checking that there is a minimum threshold pressure in the pipes via the pressure indicator and correcting the system where appropriate if there is not; closing the faucet thereby halting the fluid flow; and resetting the pressure indicator 54.

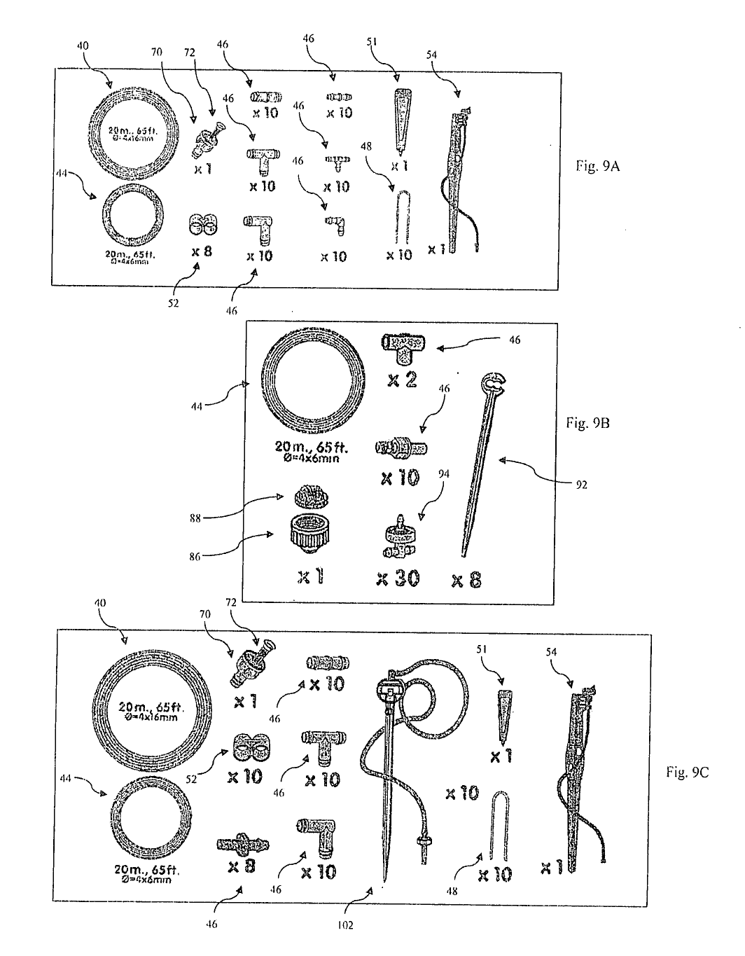

FIGS. 9A-23 illustrate examples of text-free self-explanatory instructions on the construction of the respective irrigation systems (30, 80, 100), which may constitute a part of the educational media included in the kits of these irrigation systems.

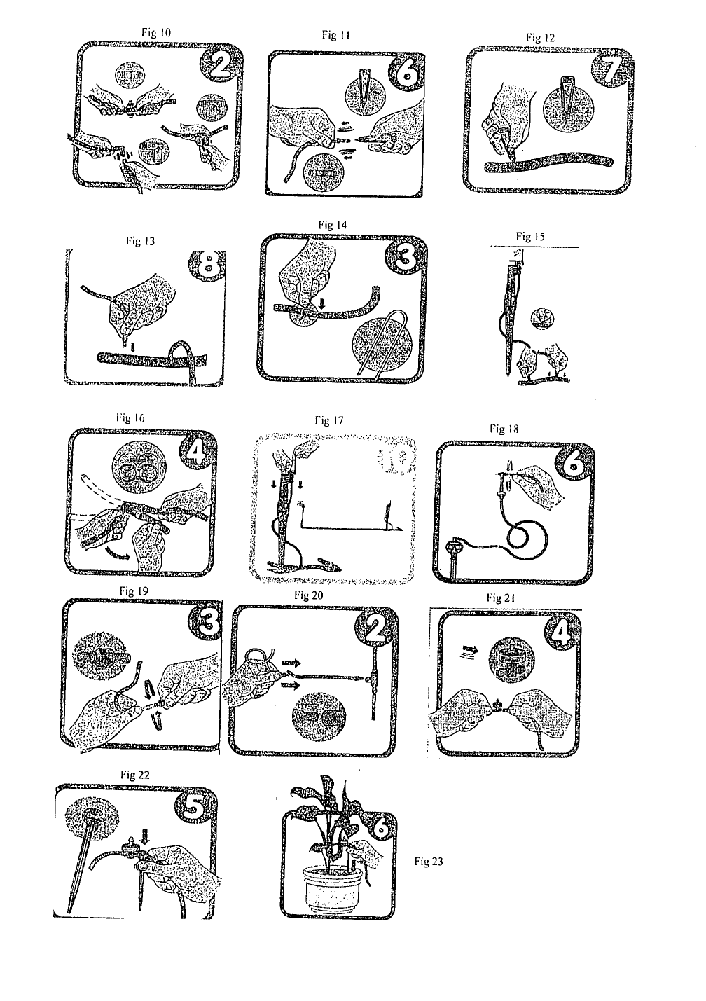

In particular, FIGS. 9A and 10-17, illustrate instructions for the construction of the irrigation system 30 shown in FIG. 1. The instructions comprise an illustration of the set of irrigation elements used in the system 30 (FIG. 9A) and the sequence of main operations (FIGS. 10-17).

It should be noted that in FIGS. 9A and 9C the element designated by the numeral 51 is a puncture tool for punching holes in pipes which would be clear to someone in possession of such.

Similarly, FIGS. 9B and 19-23, illustrate instructions for the construction of the irrigation system 80 shown in FIG. 4. The instructions comprise an illustration of the set of irrigation elements used in the system (FIG. 9B) and the sequence of main operations (FIGS. 19-23).

Similarly, FIGS. 9C and 10-18, illustrate instructions for the construction of the irrigation system 100 shown in FIG. 6. The instructions comprise an illustration of the set of irrigation elements used in the system (FIG. 9C) and the sequence of main operations (FIGS. 10-18).

As the instructions shown in the drawings are self-explanatory and elements and operations shown therein are clear without any further explanations, they should be considered as part of the present written description.

The educational media may include the following elements comprising irrigation information about the growing of plants:

a chart comprising a plurality of types of plants and a schedule indicating how often they need to have water provided to them and in what quantity;

a slide ruler instrument having movable portions and text containing plant growth information printed thereon, the portions of the ruler being selectively movable to indicate a specific portion of the text for reading; and

a notebook comprising text and pictures relating to irrigation information, empty portions for a user to write data therein, and further comprising at least one web site address directing a user to a web site containing further plant growing information such as the growth rate of specific plants which a user may wish to grow.

Additionally, the educational media may further include a computer program product comprising a computer useable medium in the form of a compact disc having computer readable program code embodied therein. When run on a computer, the computer readable program code is adapted for causing the computer to prompt for and receive inputs from a user via the computer and to subsequently display appropriate information and instructions in accordance with the inputs received. An input may be in the form of a selected age group parameter, in which case the subsequent displayed irrigation information or instructions will be at a level of sophistication suitable appropriate for the selected parameter. For example, if the user selects an age group of below 6 years, the computer displays the instructions to assemble the irrigation elements in at least one arrangement for growing plants via pictures free of text and accompanying audio instructions. Alternatively if the user selects an age group of between 6-10 years, the computer displays the instructions to assemble the irrigation elements in at least one arrangement for growing plants via colored pictures and text suitable for that age group. The computer readable program code, when run on a computer, is also adapted for causing the computer to display an irrigation simulation based on at least one received input in the form of an irrigation parameter from a user and to display an alternate irrigation simulation based on at least one further received input in the form of an irrigation parameter. The at least one irrigation is a code or name representing a set of virtual irrigation elements, or a virtual irrigation element or a virtual plant type or a virtual environmental condition or a virtual area dimension or an arrangement for virtual irrigation elements. The set of virtual irrigation elements are virtual representations of the set of irrigation elements and the virtual irrigation elements are virtual representations of real irrigation elements. The irrigation simulation further comprises a score system which enables a user to subsequently input additional irrigation parameters.

Additionally the education media may be downloaded onto a computer and saved thereto. In which case the computer may run the above described simulator from the hard-disk of a home computer or via the internet on a website containing same.

Another example of the educational media includes a web address which directs a user to a website containing further irrigation information, instructions, and an irrigation simulation program of the type described above.

Those skilled in the art to which this invention pertains will readily appreciate that numerous changes, variations and modifications can be made without departing from the scope of the invention mutatis mutandis. For example, some irrigation systems that can be built by the kit may not require the use of all of the irrigation elements in the set. Additionally, the irrigation elements may include other items that are useful in irrigation of plants and are safe for children to use, for example children-sized caps for protection against sunlight and/or signs with plant names, etc. It should be understood that alternate or additional irrigation elements may be included in other example sets thereof without departing from the scope of the invention.

1. A kit comprising a set of irrigation elements adapted for construction of an irrigation system dedicated to a certain manner of growing plants and an educational media adapted to be understood by children which includes instructions to assemble the irrigation elements to construct said irrigation system.

2. A kit according to claim 1, wherein said manner of growing is growing plants in a field having a fluid source and said set of irrigation elements comprises a main pipe having a first diameter, at least one branch pipe with a second diameter and having mounted therein or formed therewith fluid emitters, pipe connectors adapted for connection of the branch pipe to the main pipe, and a connecting assembly adapted to couple the main pipe to the fluid source.

3. A kit according to claim 2, wherein said set of irrigation elements further comprises a water tank adapted for mounting in an elevated position relative to the irrigation system, to constitute a low pressure fluid source therefor.

4. A kit according to claim 3, wherein said elevated position is defined by a predetermined height corresponding to the pressure at which the fluid emitters are adapted to operate.

5. A kit according to claim 4, wherein said tank further comprises a plurality of detachably attachable legs for elevating the tank to said predetermined height.

6. A kit according to claim 5, wherein said tank is sized to efficiently house all other irrigation elements of said kit and the plurality of detachably attachable legs therein.

7. A kit according to claim 2, wherein said connecting assembly is a detachably attachable faucet adapted for sealing connection to the tank and a flow regulator element connectable to the faucet and one of said pipe connectors or said main pipe.

8. A kit according to claim 7, wherein said detachably attachable faucet and the flow regulator are parts of a tank faucet assembly included in the set as a pre-assembled irrigation element.

9. A kit according to claim 2, wherein said fluid emitters are drip irrigation emitters or holes formed in the branch pipe.

10. A kit according to claim 2, wherein said main pipe and/or the branch pipes are capable of being cut or punched.

11. A kit according to claim 1, wherein said manner of growing is growing at least one plant in at least one pot having soil and a nearby fluid source, and said set of irrigation elements comprises pipes having fluid emitters mounted therein or formed therewith or attached thereto, pipe connectors adapted for connection of the pipes, at least one anchoring element to secure the pipes to the at least one pot, and a connecting assembly adapted to couple the pipes to the fluid source.

12. A kit according to claim 11, wherein said fluid emitters are at least one sprinkler or at least one drip emitter attached to the pipes and the set of irrigation elements further comprises a filter element.

13. A kit according to claim 1, wherein said media includes irrigation information about the growing of plants and a portion or all of said media is adapted to be understood by children within a predefined age group, by adapting the media to a level of sophistication suitable for the predefined age group.

14. An irrigation kit comprising a set of irrigation elements adapted for construction of an irrigation system in a field having soil comprising: a water tank adapted to constitute a fluid source for the irrigation system, having a plurality of legs detachably attachable thereto for elevating the tank to a predetermined height relative to the irrigation system, when attached thereto

15. The irrigation kit of claim 14, wherein said set of irrigation elements further comprises a detachably attachable tank faucet assembly adapted for sealing connection of a pipe to the tank and wherein the tank is sized to efficiently house all other irrigation elements of the set and the legs therein.

16. The irrigation kit of claim 14, further comprising an educational media adapted to be understood by children which includes irrigation information about the growing of plants and instructions to assemble the irrigation elements to construct said irrigation system.

17. A method for educating children about irrigation comprising the following steps:
(a) providing a set of irrigation elements adapted for construction of an irrigation system dedicated to a certain manner of growing plants;
(b) providing an educational media adapted to be understood by children which includes irrigation information about the growing of plants and instructions to assemble the irrigation elements to construct the irrigation system.

18. The method according to claim 17, wherein said educational media comprises a program storage device readable by machine, tangibly embodying a program of instructions executable by the machine.

19. The method according to claim 18, wherein said program storage device is in the form of a CD or a computer hard drive.

20. The method according to claim 17, wherein said education media includes a computer program in the form of an irrigation simulator comprising computer program code means for causing a computer to display an irrigation simulation which may perform any of the following steps:
(a) receiving an input in the form of a selected age group parameter, and displaying the irrigation information at a level of sophistication suitable appropriate for the selected parameter;
(b) receiving an input in the form of an irrigation parameter and starting an irrigation simulation on the basis thereof;
(c) when the irrigation simulation has started, receiving at least one input in the form of an irrigation parameter and altering the irrigation simulation based thereon;
(d) providing a score system which enables a user to subsequently input additional irrigation parameters;
when said program is run on a computer.
